(19) United States
(12) Patent Application Publication
(10) Pub. No.: US 2015/0287515 A1
(43) Pub. Date: Oct. 8, 2015

(54) MULTILAYER ARRAY ELECTRONIC COMPONENT AND METHOD OF MANUFACTURING THE SAME

(71) Applicant: SAMSUNG ELECTRO-MECHANICS CO., LTD., Suwon-Si (KR)

(72) Inventor: Kwang Sun CHOI, Suwon-Si (KR)

(21) Appl. No.: 14/448,594

(22) Filed: Jul. 31, 2014

(30) Foreign Application Priority Data
Apr. 2, 2014 (KR) 10-2014-0039441

(51) Int. Cl. H01F 27/28; H01F 41/10; H01F 27/24; H01F 41/04

(52) U.S. Cl. CPC H01F 27/2804; H01F 41/041; H01F 41/10; H01F 27/24; H01F 2027/2809

(57) ABSTRACT

A multilayer array electronic component may include: a ceramic body in which a plurality of non-magnetic layers are stacked; a plurality of internal coil parts in which internal coil patterns respectively disposed on the plurality of non-magnetic layers are connected to each other by a via electrode penetrating through the non-magnetic layer; and a plurality of input terminals connected to first lead-out portions of the plurality of internal coil parts, respectively, and a plurality of output terminals connected to second lead-out portions of the plurality of internal coil parts, respectively. The plurality of internal coil parts may include first and second internal coil portions that are not electrically connected to each other, and formation directions of the first and second internal coil portions may be opposite to each other.

### CROSS-REFERENCE TO RELATED APPLICATION

This application claims the benefit of Korean Patent Application No. 10-2014-0039441 filed on Apr. 2, 2014, with the Korean Intellectual Property Office, the disclosure of which is incorporated herein by reference.

### BACKGROUND

The present disclosure relates to a multilayer array electronic component and a method of manufacturing the same.

In order to decrease amounting area of passive elements mounted on a printed circuit board, an array type inductor in which a plurality of internal coils are disposed is used.

Further, in accordance with an increase in high performance integrated circuits (IC) due to progress of a semiconductor manufacturing technology, power used therefor has been increased, and usage of high current has been increased. However, by arraying electronic components, a low level of current may be applied.

The array type inductor has a coupling structure in which a plurality of internal coils connected to an input terminal and an output terminal have a single direction in which current flows and a de-coupling structure in which directions of flow of currents are different.

In the case of the de-coupling structure, an influence by mutual induction may be small, such that efficiency in a high current band may be excellent, but since a coupling coefficient is low, efficiency in a low current band may be decreased.

### RELATED ART DOCUMENT

Japanese Patent Laid-Open Publication No. 2001-023822

### SUMMARY

An exemplary embodiment in the present disclosure may provide a multilayer array electronic component having an improved coupling coefficient in spite of having a structure in which internal coils are de-coupled to thereby improve efficiency in a low current band, and a method of manufacturing the same.

According to an exemplary embodiment in the present disclosure, a multilayer array electronic component may include: a ceramic body in which a plurality of non-magnetic layers are stacked; a plurality of internal coil parts in which internal coil patterns respectively disposed on the plurality of non-magnetic layers are connected to each other by a via electrode penetrating through the non-magnetic layer; and a plurality of input terminals connected to first lead-out portions of the plurality of internal coil parts, respectively, and a plurality of output terminals connected to second lead-out portions of the plurality of internal coil parts, respectively, the plurality of input terminals and output terminals being disposed on both side surfaces of the ceramic body in a width direction, wherein the plurality of internal coil parts include first and second internal coil portions that are not electrically connected to each other, and formation directions of the first and second internal coil portions are opposite to each other.

The multilayer array electronic component may further include upper and lower cover layers containing a magnetic material and disposed on upper and lower portions of the ceramic body.

The non-magnetic layer may contain glass containing one or more selected from a group consisting of zinc (Zn), copper (Cu), iron (Fe), silicon (Si), titanium (Ti), aluminum (Al), zirconium (Zr), bismuth (Bi), and boron (B).

The non-magnetic layer may include a magnetic part disposed in a central portion of the non-magnetic layer.

The magnetic part may be disposed at an interval equal to or greater than a distance equal to ⅕ of a line width of the internal coil pattern from the internal coil pattern disposed on the non-magnetic layer.

The magnetic material may contain one or more selected from a group consisting of Mn—Zn based ferrite, Ni—Zn based ferrite, Ni—Zn—Cu based ferrite, Mn—Mg based ferrite, Ba based ferrite, and Li based ferrite.

According to an exemplary embodiment in the present disclosure, a multilayer array electronic component may include: a ceramic body in which a plurality of magnetic or non-magnetic layers are stacked; first and second internal coil portions disposed in the ceramic body and including a plurality of internal coil patterns connected to each other by a via electrode; and first and second input terminals connected to first lead-out portions of the first and second internal coil portions, respectively, and first and second output terminals connected to second lead-out portions of the first and second internal coil portions, respectively, wherein the internal coil pattern is formed on the non-magnetic layer, and formation directions of the first and second internal coil portions are opposite to each other.

The multilayer array electronic component may further include upper and lower cover layers containing a magnetic material and disposed on upper and lower portions of the ceramic body.

The non-magnetic layer may contain glass containing one or more selected from a group consisting of zinc (Zn), copper (Cu), iron (Fe), silicon (Si), titanium (Ti), aluminum (Al), zirconium (Zr), bismuth (Bi), and boron (B).

The non-magnetic layer may include a magnetic part disposed in a central portion of the non-magnetic layer.

The magnetic part may be disposed at an interval equal to or greater than a distance equal to ⅕ of a line width of the internal coil pattern from the internal coil pattern disposed on the non-magnetic layer.

The magnetic layer may contain one or more selected from a group consisting of Mn—Zn based ferrite, Ni—Zn based ferrite, Ni—Zn—Cu based ferrite, Mn—Mg based ferrite, Ba based ferrite, and Li based ferrite.

According to an exemplary embodiment in the present disclosure, a method of manufacturing a multilayer array electronic component may include: preparing a plurality of non-magnetic sheets; forming an internal coil pattern on the non-magnetic sheet; stacking the non-magnetic sheets on which the internal coil pattern is formed to form a ceramic body including a plurality of internal coil parts; and forming a plurality of input terminals connected to first lead-out portions of the plurality of internal coil parts, respectively, and a plurality of output terminals connected to second lead-out portions of the plurality of internal coil parts, respectively, on both side surfaces of the ceramic body in a width direction, wherein the plurality of internal coil parts include first and second internal coil portions that are not electrically connected to each other, and formation directions of the first and second internal coil portions are opposite to each other.

The method may further include stacking a magnetic sheet on upper and lower portions of the stacked non-magnetic sheets, after the stacking of the non-magnetic sheet on which the internal coil pattern is formed, so as to form upper and lower cover layers containing a magnetic material.

The non-magnetic sheet may contain glass containing one or more selected from a group consisting of zinc (Zn), copper (Cu), iron (Fe), silicon (Si), titanium (Ti), aluminum (Al), zirconium (Zr), bismuth (Bi), and boron (B).

The non-magnetic sheet may be provided with a magnetic part formed in a central portion of the non-magnetic sheet to then be stacked so as to form a magnetic core part penetrating through the internal coil part.

The magnetic part may be disposed at an interval equal to or greater than a distance equal to ⅕ of a line width of the internal coil pattern from the internal coil pattern disposed on the non-magnetic sheet.

The magnetic material may contain one or more selected from a group consisting of Mn—Zn based ferrite, Ni—Zn based ferrite, Ni—Zn—Cu based ferrite, Mn—Mg based ferrite, Ba based ferrite, and Li based ferrite.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view of a multilayer array electronic component according to an exemplary embodiment of the present disclosure;

FIG. 2 is a cross-sectional view taken along line I-I′ of FIG. 1;

FIG. 3 is an exploded perspective view of a multilayer array electronic component according to an exemplary embodiment of the present disclosure;

FIG. 4 is an exploded perspective view of a multilayer array electronic component according to another exemplary embodiment of the present disclosure;

FIG. 5 is an exploded perspective view of a multilayer array electronic component according to another exemplary embodiment of the present disclosure;

FIG. 6 is an exploded perspective view of a multilayer array electronic component according to another exemplary embodiment of the present disclosure;

FIG. 7 is a view illustrating a non-magnetic layer of which a magnetic part is formed in a central portion according to an exemplary embodiment of the present disclosure; and

FIG. 8 is a process view illustrating a method of manufacturing a multilayer array electronic component according to an exemplary embodiment of the present disclosure.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements maybe exaggerated for clarity, and the same reference numerals will be used throughout to designate the same or like elements.

Multilayer Array Electronic Component

Hereinafter, a multilayer array electronic component according to an exemplary embodiment of the present disclosure will be described. In detail, a multilayer inductor array will be described, but the present disclosure is not limited thereto.

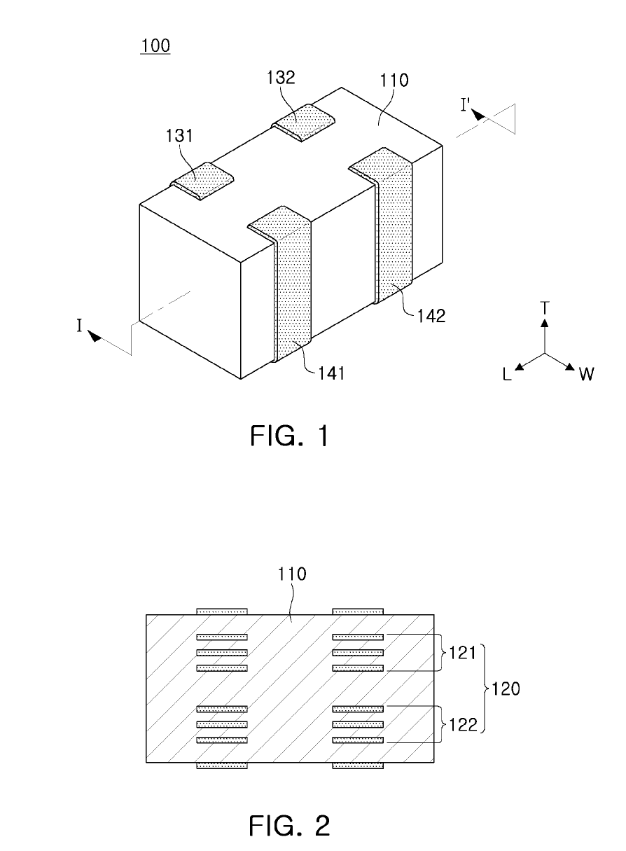

FIG. 1 is a perspective view of a multilayer array electronic component according to an exemplary embodiment of the present disclosure, and FIG. 2 is a cross-sectional view taken along line I-I′ of FIG. 1.

Referring to FIGS. 1 and 2, the multilayer array electronic component 100 according to an exemplary embodiment of the present disclosure may include a ceramic body 110, a plurality of internal coil parts 120 disposed in the ceramic body 110, and input terminals 131 and 132 and output terminals 141 and 142 disposed on both side surfaces of the ceramic body 110 in a width direction.

The ceramic body 110 may have a hexahedral shape, and a direction of the hexahedron will be defined in order to clearly describe exemplary embodiments of the present disclosure. L, W and T shown in FIG. 1 refer to a length direction, a width direction, and a thickness direction, respectively.

In the ceramic body 110, a plurality of magnetic layers or non-magnetic layers may be in a sintered state, and adjacent magnetic or non-magnetic layers are integrated with each other so that boundaries therebetween are not readily apparent without a scanning electron microscope (SEM).

The plurality of internal coil parts 120 formed in the ceramic body 110 may include first and second internal coil portions 121 and 122 that are not electrically connected to each other. The first and second internal coil portions 121 and 122 are not connected to each other by a via electrode, and further, are insulated from each other by a non-magnetic layer 111. As described above, the first and second internal coil portions 121 and 122 are not electrically connected to each other, but are disposed as separate internal coil parts in the ceramic body 110, thereby forming an array type electronic component.

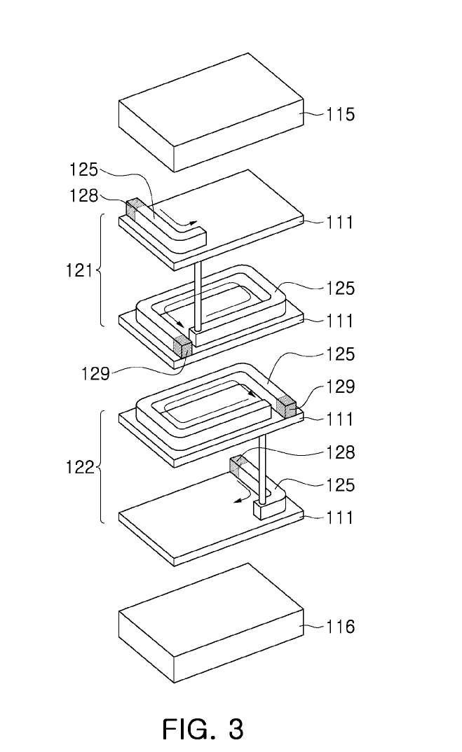

FIGS. 3 through 6 are exploded perspective views of a multilayer array electronic component according to an exemplary embodiment of the present disclosure.

Referring to FIG. 3, internal coil patterns 125 formed on a plurality of non-magnetic layers 111 may be connected to each other by a via electrode (not shown), thereby forming the first and second internal coil portions 121 and 122.

The first and second internal coil portions 121 and 122 may respective have a first lead-out portion 128 exposed to one side surface of the ceramic body 110 in the width direction and a second lead-out portion 129 exposed to the other side surface of the ceramic body 110 in the width direction.

The first lead-out portions 128 of the first and second internal coil portions 121 and 122 may be connected to the input terminals 131 and 132 formed on one side surface of the ceramic body 110 in the width direction, respectively, and the second lead-out portions 129 of the first and second internal coil portions 121 and 122 may be connected to the output terminals 141 and 142 formed on the other side surface of the ceramic body 110.

The first and second internal coil portions 121 and 122 may have a de-coupling structure in which formation directions thereof are opposite to each other.

For example, the formation direction from the first lead-out portion 128 of the first internal coil portion 121 connected to the input terminal 131 to the second lead-out portion 129 of the first internal coil portion 121 connected to the output terminal 141 may be counter-clockwise, and the formation direction from the first lead-out portion 128 of the second internal coil portion 122 connected to the input terminal 132 to the second lead-out portion 129 of the second internal coil portion 122 connected to the output terminal 142 may be clockwise.

In this case, as the internal coil patterns 125 forming the first and second internal coil portions 121 and 122 are formed on the non-magnetic layer 111, a coupling coefficient may be improved. When the coupling coefficient is improved, even in the case of a de-coupling structure, efficiency may also be improved in a relatively low current band as well as in a high current band.

The non-magnetic layer 111 may contain glass, and the glass may contain one or more selected from a group consisting of zinc (Zn), copper (Cu), iron (Fe), silicon (Si), titanium (Ti), aluminum (Al), zirconium (Zr), bismuth (Bi), and boron (B).

The internal coil pattern 125 may be formed by printing a conductive paste containing a conductive metal. The conductive metal is not particularly limited as long as the metal has excellent electric conductivity. For example, as the metal, silver (Ag), palladium (Pd), aluminum (Al), nickel (Ni), titanium (Ti), gold (Au), copper (Cu), platinum (Pt), or the like, may be used alone, or a mixture thereof may be used.

Upper and lower cover layers 115 and 116 formed by stacking a plurality of magnetic layers may be disposed on upper and lower portions of the first and second internal coil portions 121 and 122.

Inductance may be increased by forming the upper and lower cover layers 115 and 116 containing a magnetic material.

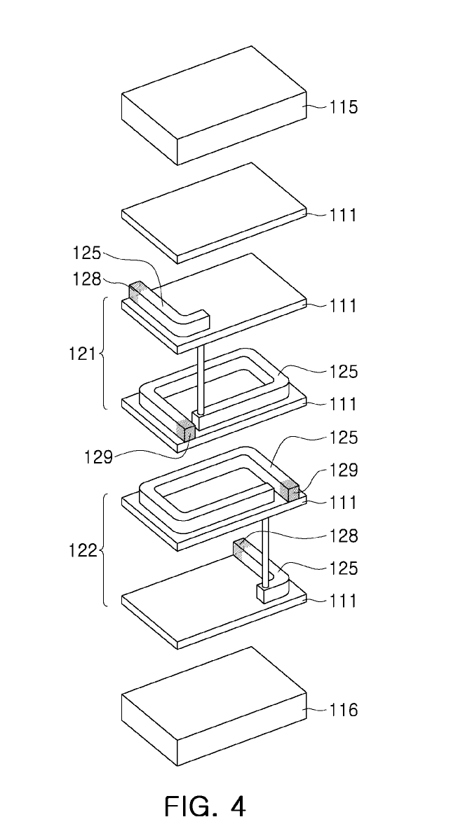

Referring to FIG. 4, the multilayer array electronic component may further include a non-magnetic layer 111 on which an internal coil pattern 125 is not formed in addition to an non-magnetic layer 111 on which the internal coil pattern 125 is formed.

A deviation in inductance between first and second internal coil portions 121 and 122 may be decreased by stacking the non-magnetic layer 111 on which the internal coil pattern 125 is not formed so as to be adjacent to the first or second internal coil portion 121 or 122.

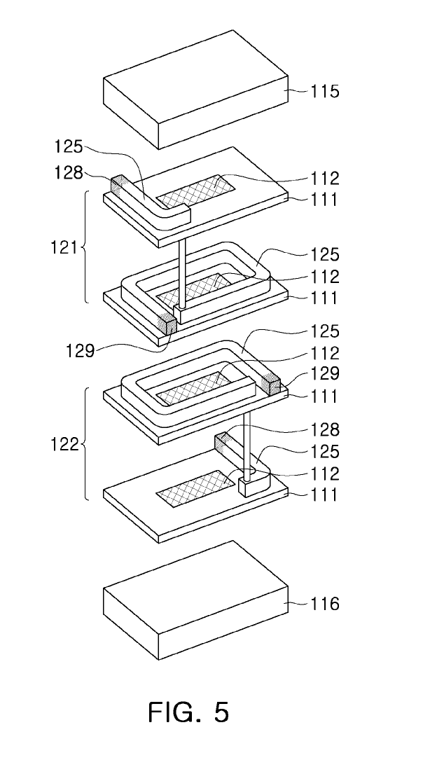

Referring to FIG. 5, a magnetic part 112 may be disposed in a central portion of a non-magnetic layer 111 on which an internal coil pattern 125 is formed.

Inductance may be easily implemented by forming the magnetic part 112 in the central portion of the non-magnetic layer 111.

The magnetic part 112 may contain commonly known ferrite such as Mn—Zn based ferrite, Ni—Zn based ferrite, Ni—Zn—Cu based ferrite, Mn—Mg based ferrite, Ba based ferrite, Li based ferrite, or the like.

The magnetic part 112 is formed in the central portion of the non-magnetic layer 111 on which the internal coil pattern 125 is formed, and such magnetic parts 112 are continuously stacked such that a magnetic core part penetrating through the internal coil part 120 may be formed.

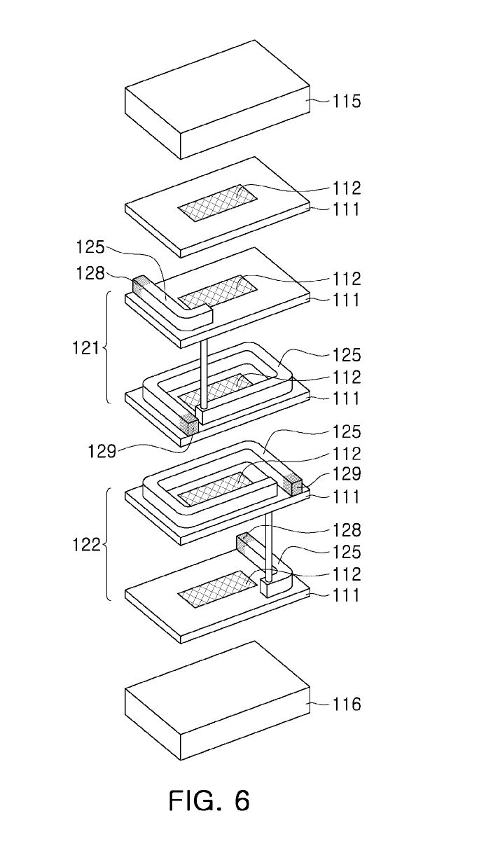

Referring to FIG. 6, a magnetic part 112 may be formed in a central portion of a non-magnetic layer on which an internal coil pattern 125 is not formed, in addition to the formation thereof on the non-magnetic layer 111 on which the internal coil pattern 125 is formed.

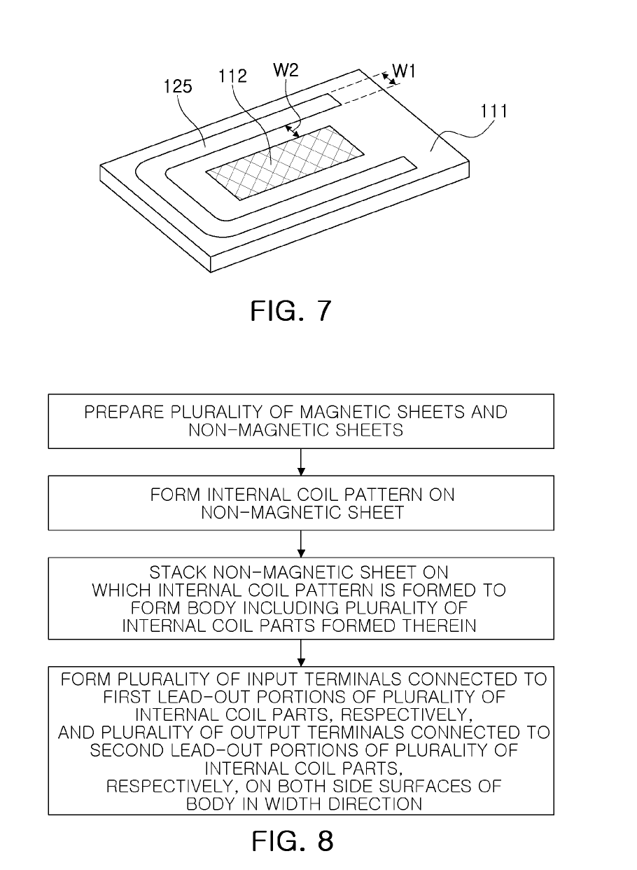

FIG. 7 is a view illustrating a non-magnetic layer of which a magnetic part is formed in a central portion thereof according to an exemplary embodiment of the present disclosure.

Referring to FIG. 7, the magnetic part 112 formed in the central portion of the non-magnetic layer 111 may be formed at an interval equal to or greater than a distance equal to ⅕ of a line width W1 of the internal coil pattern 125 from the internal coil pattern 125 formed on the non-magnetic layer 111.

For example, an interval W2 between the magnetic part 112 and the internal coil pattern 125 may be equal to or greater than a distance equal to ⅕ of the line width W1 of the internal coil pattern 125.

In the case in which the interval between the magnetic part 112 and the internal coil pattern 125 is less than a distance equal to ⅕ of the line width W1 of the internal coil pattern 125, the coupling coefficient of the first and second internal coil portions 121 and 122 may be decreased.

The following Table 1 shows a coupling coefficient in the case of first and second internal coil portions having a de-coupling structure in which all internal coil patterns are formed on a magnetic layer (Comparative Example) and coupling coefficients in the cases according to exemplary embodiments of the present disclosure of FIGS. 3 through 6.

TABLE 1

| | Comparative | | | | |
|---|---|---|---|---|---|
| | Example | FIG. 3 | FIG. 4 | FIG. 5 | FIG. 6 |
| Coupling | 0.32 | 0.84 | 0.85 | 0.87 | 0.88 |
| Coefficient | | | | | |

As shown in Table 1, in the case of Comparative Example in which the internal coil part is formed on the magnetic layer, the coupling coefficient is 0.32, but in the cases according to exemplary embodiments of the present disclosure of FIGS. 3 through 6 in which the internal coil part is formed on the non-magnetic layer, the coupling coefficient is significantly increased (0.84˜0.88). Therefore, even in the case of the de-coupling structure, efficiency in the low current band may also be improved.

Method of Manufacturing Multilayer Array Electronic Component

FIG. 8 is a process view illustrating a method of manufacturing a multilayer array electronic component according to an exemplary embodiment of the present disclosure.

Referring to FIG. 8, first, a plurality of non-magnetic sheets may be prepared.

A non-magnetic material used in the non-magnetic sheet may contain glass, and the glass may contain one or more selected from a group consisting of zinc (Zn), copper (Cu), iron (Fe), silicon (Si), titanium (Ti), aluminum (Al), zirconium (Zr), bismuth (Bi), and boron (B).

Slurry formed by mixing the non-magnetic material, a binder, a plasticizer, a solvent, and the like, may be applied onto a carrier film to then be dried, thereby preparing a plurality of non-magnetic sheets.

Next, an internal coil pattern 125 may be formed on the non-magnetic sheet.

The internal coil pattern 125 may be formed by applying a conductive paste containing a conductive metal to the non-magnetic sheet using a printing method, or the like.

The conductive metal is not particularly limited as long as the metal has excellent electric conductivity. For example, as the conductive metal, silver (Ag), palladium (Pd), aluminum (Al), nickel (Ni), titanium (Ti), gold (Au), copper (Cu), platinum (Pt), or the like, may be used alone, or a mixture thereof may be used.

As the printing method of the conductive paste, a screen printing method, a gravure printing method, or the like, may be used, but the present disclosure is not limited thereto.

Then, the non-magnetic sheets on which the internal coil pattern 125 is formed may be stacked, thereby forming a ceramic body 110 including a plurality of internal coil parts 120 formed therein.

The plurality of internal coil parts 120 formed in the ceramic body 110 may include first and second internal coil portions 121 and 122 that are not electrically connected to each other.

The internal coil patterns 125 formed on the plurality of non-magnetic sheets may be electrically connected to each other by a via electrode (not shown), thereby forming the first and second internal coil portions 121 and 122.

Each of the first and second internal coil portions 121 and 122 may have a first lead-out portion 128 exposed to one side surface of the ceramic body 110 in the width direction and a second lead-out portion 129 exposed to the other side surface of the ceramic body 110 in the width direction.

The first and second internal coil portions 121 and 122 may have a de-coupling structure in which formation directions thereof are opposite to each other.

In this case, as the internal coil pattern 125 is formed on the non-magnetic sheet and the non-magnetic sheets on which the internal coil pattern 125 is formed are stacked to thereby form the first and second internal coil portions 121 and 122, a coupling coefficient may be improved. When the coupling coefficient is improved, even in the case of the de-coupling structure, efficiency may also be improved in a low current band as well as in a high current band.

A non-magnetic sheet on which the internal coil pattern 125 is not formed may be further stacked in addition to the formation of the non-magnetic sheet on which the internal coil pattern 125 is formed.

A deviation in inductance between first and second internal coil portions 121 and 122 may be decreased by stacking the non-magnetic sheets on which the internal coil pattern 125 is not formed, so as to be adjacent to the first or second internal coil portion 121 or 122.

In addition, a magnetic part 112 may be disposed in a central portion of the non-magnetic sheet on which the internal coil pattern 125 is formed.

Inductance may be easily implemented by forming the magnetic part 112 in the central portion of the non-magnetic sheet.

The magnetic part 112 may contain commonly known ferrite such as Mn—Zn based ferrite, Ni—Zn based ferrite, Ni—Zn—Cu based ferrite, Mn—Mg based ferrite, Ba based ferrite, Li based ferrite, or the like.

The magnetic part 112 is formed in the central portion of the non-magnetic sheet on which the internal coil pattern 125 is formed, and the formed magnetic parts 112 are continuously stacked, such that a magnetic core part penetrating through the internal coil part 120 may be formed.

The magnetic part 112 may also be formed in a central portion of the non-magnetic sheet on which the internal coil pattern 125 is not formed, in addition to that of the non-magnetic sheet on which the internal coil pattern 125 is formed.

The magnetic part 112 formed in the central portion of the non-magnetic sheet may be formed at an interval equal to or greater than a distance equal to ⅕ of a line width W1 of the internal coil pattern 125 from the internal coil pattern 125 formed on the non-magnetic sheet.

For example, an interval W2 between the magnetic part 112 and the internal coil pattern 125 maybe equal to or greater than a distance equal to ⅕ of the line width W1 of the internal coil pattern 125.

In the case in which the interval between the magnetic part 112 and the internal coil pattern 125 is less than a distance equal to ⅕ of the line width W1 of the internal coil pattern 125, the coupling coefficient of the first and second internal coil portions 121 and 122 may be decreased.

After stacking the non-magnetic sheets on which the internal coil pattern 125 is formed, upper and lower cover layers 115 and 116 containing a magnetic material may be formed by stacking a plurality of magnetic sheets on upper and lower portions of the stacked non-magnetic sheets.

Inductance may be increased by forming the upper and lower cover layers 115 and 116 containing the magnetic material.

Thereafter, a plurality of input terminals 131 and 132 connected to first lead-out portions 128 of the first and second internal coil portions 121 and 122, respectively, may be disposed on one side surface of the ceramic body 110 in a width direction, and a plurality of output terminals 141 and 142 connected to second lead-out portions 129 of the first and second internal coil portions 121 and 122, respectively, may be disposed on the other side surface of the ceramic body 110 in the width direction.

The input terminals 131 and 132 and the output terminals 141 and 142 may be formed using a metal having excellent electric conductivity. For example, the input terminals 131 and 132 and the output terminals 141 and 142 may be formed using one of nickel (Ni), copper (Cu), tin (Sn), silver (Ag), and the like, an alloy thereof, or the like.

According to shapes of the input terminals 131 and 132 and the output terminals 141 and 142, the input terminals 131 and 132 and the output terminals 141 and 142 may be formed by a dipping method, or the like, as well as a printing method.

According to exemplary embodiments of the present disclosure, the multilayer array electronic component has a structure in which internal coils are de-coupled but has a high coupling coefficient, such that efficiency of a power management integrated circuit (PMIC) or a DC-DC converter in the low current band (standby mode) may be improved.

In addition, due to the de-coupling structure, an influence by mutual induction may be significantly decreased, such that efficiency in the high current band (operation mode) may also be improved.

While exemplary embodiments have been shown and described above, it will be apparent to those skilled in the art that modifications and variations could be made without departing from the spirit and scope of the present disclosure as defined by the appended claims.

1. A multilayer array electronic component comprising:
a ceramic body in which a plurality of non-magnetic layers are stacked;
a plurality of internal coil parts in which internal coil patterns respectively disposed on the plurality of non-magnetic layers are connected to each other by a via electrode penetrating through the non-magnetic layer; and
a plurality of input terminals connected to first lead-out portions of the plurality of internal coil parts, respectively, and a plurality of output terminals connected to second lead-out portions of the plurality of internal coil parts, respectively, the plurality of input terminals and output terminals being disposed on both side surfaces of the ceramic body in a width direction,
wherein the plurality of internal coil parts include first and second internal coil portions that are not electrically connected to each other, and formation directions of the first and second internal coil portions are opposite to each other.

2. The multilayer array electronic component of claim 1, further comprising upper and lower cover layers containing a magnetic material and disposed on upper and lower portions of the ceramic body.

3. The multilayer array electronic component of claim 1, wherein the non-magnetic layer contains glass containing one or more selected from a group consisting of zinc (Zn), copper (Cu), iron (Fe), silicon (Si), titanium (Ti), aluminum (Al), zirconium (Zr), bismuth (Bi), and boron (B).

4. The multilayer array electronic component of claim 1, wherein the non-magnetic layer includes a magnetic part disposed in a central portion of the non-magnetic layer.

5. The multilayer array electronic component of claim 4, wherein the magnetic part is disposed at an interval equal to or greater than a distance equal to ⅕ of a line width of the internal coil pattern from the internal coil pattern disposed on the non-magnetic layer.

6. The multilayer array electronic component of claim 2, wherein the magnetic material contains one or more selected from a group consisting of Mn—Zn based ferrite, Ni—Zn based ferrite, Ni—Zn—Cu based ferrite, Mn—Mg based ferrite, Ba based ferrite, and Li based ferrite.

7. A multilayer array electronic component comprising:
a ceramic body in which a plurality of magnetic or non-magnetic layers are stacked;
first and second internal coil portions disposed in the ceramic body and including a plurality of internal coil patterns connected to each other by a via electrode; and
first and second input terminals connected to first lead-out portions of the first and second internal coil portions, respectively, and first and second output terminals connected to second lead-out portions of the first and second internal coil portions, respectively,
wherein the internal coil pattern is formed on the non-magnetic layer, and formation directions of the first and second internal coil portions are opposite to each other.

8. The multilayer array electronic component of claim 7, further comprising upper and lower cover layers containing a magnetic material and disposed on upper and lower portions of the ceramic body.

9. The multilayer array electronic component of claim 7, wherein the non-magnetic layer contains glass containing one or more selected from a group consisting of zinc (Zn), copper (Cu), iron (Fe), silicon (Si), titanium (Ti), aluminum (Al), zirconium (Zr), bismuth (Bi), and boron (B).

10. The multilayer array electronic component of claim 7, wherein the non-magnetic layer includes a magnetic part disposed in a central portion of the non-magnetic layer.

11. The multilayer array electronic component of claim 10, wherein the magnetic part is disposed at an interval equal to or greater than a distance equal to ⅕ of a line width of the internal coil pattern from the internal coil pattern disposed on the non-magnetic layer.

12. The multilayer array electronic component of claim 7, wherein the magnetic layer contains one or more selected from a group consisting of Mn—Zn based ferrite, Ni—Zn based ferrite, Ni—Zn—Cu based ferrite, Mn—Mg based ferrite, Ba based ferrite, and Li based ferrite.

13. A method of manufacturing a multilayer array electronic component, the method comprising:
preparing a plurality of non-magnetic sheets;
forming an internal coil pattern on the non-magnetic sheet;
stacking the non-magnetic sheets on which the internal coil pattern is formed to form a ceramic body including a plurality of internal coil parts; and
forming a plurality of input terminals connected to first lead-out portions of the plurality of internal coil parts, respectively, and a plurality of output terminals connected to second lead-out portions of the plurality of internal coil parts, respectively, on both side surfaces of the ceramic body in a width direction,
wherein the plurality of internal coil parts include first and second internal coil portions that are not electrically connected to each other, and formation directions of the first and second internal coil portions are opposite to each other.

14. The method of claim 13, further comprising, after the stacking of the non-magnetic sheet on which the internal coil pattern is formed, stacking a magnetic sheet on upper and lower portions of the stacked non-magnetic sheets to form upper and lower cover layers containing a magnetic material.

15. The method of claim 13, wherein the non-magnetic sheet contains glass containing one or more selected from a group consisting of zinc (Zn), copper (Cu), iron (Fe), silicon (Si), titanium (Ti), aluminum (Al), zirconium (Zr), bismuth (Bi), and boron (B).

16. The method of claim 3, wherein the non-magnetic sheet is provided with a magnetic part formed in a central portion of the non-magnetic sheet to then be stacked so as to form a magnetic core part penetrating through the internal coil part.

17. The method of claim 16, wherein the magnetic part is disposed at an interval equal to or greater than a distance equal to ⅕ of a line width of the internal coil pattern from the internal coil pattern disposed on the non-magnetic sheet.

18. The method of claim 14, wherein the magnetic material contains one or more selected from a group consisting of Mn—Zn based ferrite, Ni—Zn based ferrite, Ni—Zn—Cu based ferrite, Mn—Mg based ferrite, Ba based ferrite, and Li based ferrite.
